(19) United States
(12) Patent Application Publication
(10) Pub. No.: US 2026/0109292 A1
(43) Pub. Date: Apr. 23, 2026

(54) DRIVER STATE DETECTION DEVICE, DRIVER STATE DETECTION METHOD, AND STORAGE MEDIUM

(71) Applicant: HONDA MOTOR CO., LTD., Tokyo (JP)

(72) Inventors: Hirotaka Katayama, Tokyo (JP); Yuichi Masukake, Wako-shi (JP); Kazuma Hamada, Tokyo (JP)

(21) Appl. No.: 19/359,734

(22) Filed: Oct. 16, 2025

(30) Foreign Application Priority Data
Oct. 18, 2024 (JP) 2024-183253

(51) Int. Cl. B60Q 9/00; G06V 20/59; G07C 5/02

(52) U.S. Cl. CPC B60Q 9/00; G06V 20/597; G07C 5/02

(57) ABSTRACT

A driver state detection device includes a recognizer configured to recognize at least one of a gaze and a face direction of a driver of a mobile object and a determiner configured to determine whether the driver is performing sideways-glance driving based on a result of recognition and a sideways-glance determination condition. The determiner performs the determination of sideways-glance driving using a first sideways-glance determination condition when a swing of the mobile object is not predicted and when the mobile object is not swinging, performs the determination of sideways-glance driving using a second sideways-glance determination condition when a swing of the mobile object is predicted or when the mobile object is swinging, and changes a swing determination condition for determining whether the mobile object is swinging according to whether a swinging direction of the mobile object is right or left when it is determined whether the mobile object is swinging.

### CROSS-REFERENCE TO RELATED APPLICATION

Priority is claimed on Japanese Patent Application No. 2024-183253, filed October 18, 2024, the content of which is incorporated herein by reference.

### BACKGROUND

### Field of the Invention

The present invention relates to a driver state detection device, a driver state detection method, and a storage medium.

### Description of Related Art

Recently, countermeasures for providing access to a sustainable transportation system in which vulnerable persons out of traffic participants are also considered have been actively studied. In order to realize such countermeasures, focus has been concentrated on research and development for further improving safety or convenience of traffic through research and development on preventive safety technology. In this regard, a technique of acquiring first detection information indicating a gaze or a face direction of a driver, determining whether the driver is glancing sideways on the basis of the gaze or the direction of the face of the driver indicated by the first detection information and a first determination condition set to determine sideways-glance driving, acquiring second detection information indicating an angular velocity around a vertical axis or a lateral acceleration of a vehicle, and changing the first determination condition to a second determination condition different from the first determination condition in a period in which an angular velocity or a lateral acceleration not satisfying a preset criterion is being detected on the basis of the second detection information is known in the related art (for example, see Japanese Unexamined Patent Application, First Publication No. 2019-91281).

### SUMMARY

In such preventive safety technology according to the related art, since a sideways-glance determination condition of a driver is not changed when a mobile object is fluctuating laterally due to driving or the mobile object is traveling on a curved road or the like, appropriate sideways-glance determination may not be performed in some moving situations of the mobile object. Accordingly, a driver’s state may not be able to be appropriately detected.

In order to solve the aforementioned problem, an objective of the present invention is to provide a driver state detection device, a driver state detection method, and a storage medium that can more appropriately detect a driver state according to a moving situation of a mobile object. Another objective thereof is to contribute to advancement of a sustainable transportation system.

A driver state detection device, a driver state detection method, and a storage medium according to the present invention employ the following configurations.

(1) According to an aspect of the present invention, there is provided a driver state detection device including: a recognizer configured to recognize at least one of a gaze and a face direction of a driver of a mobile object; and a determiner configured to determine whether the driver is performing sideways-glance driving on the basis of a result of recognition from the recognizer and a sideways-glance determination condition, wherein the determiner performs the determination of sideways-glance driving using a first sideways-glance determination condition when a swing of the mobile object is not predicted and when the mobile object is not swinging, the determiner performs the determination of sideways-glance driving using a second sideways-glance determination condition when a swing of the mobile object is predicted or when the mobile object is swinging, and the determiner changes a swing determination condition for determining whether the mobile object is swinging according to whether a swinging direction of the mobile object is right or left when it is determined whether the mobile object is swinging.

(2) In the aspect of (1), the swing may include right and left turns of the mobile object, and the determiner may set the swing determination condition such that the sideways-glance determination condition changes more easily when the mobile object performs a right turn or a left turn without crossing an opposing lane opposing a lane in which the mobile object is moving than when the mobile object performs a right turn or a left turn while crossing the opposing lane.

(3) In the aspect of (2), the determiner may set the swing determination condition such that the sideways-glance determination condition changes when the mobile object performs a right turn or a left turn without crossing the opposing lane and the driver’s operation of a direction indicator of the mobile object is detected and the sideways-glance determination condition changes when the mobile object performs a right turn or a left turn while crossing the opposing lane and a driving operation of causing lateral behavior of the mobile object or lateral behavior of the mobile object is detected.

(4) In the aspect of (1), whether the mobile object is swinging may be determined when a speed or an amount of deceleration of the mobile object is less than a threshold value.

(5) In the aspect of (1), the determiner may change the swing determination condition on the basis of a reliability of the result of recognition from the recognizer.

(6) In the aspect of (5), the determiner may loosen the sideways-glance determination condition earlier when the reliability is less than a threshold value than when the reliability is equal to or greater than the threshold value.

(7) In the aspect of (1), the determiner may loosen the sideways-glance determination condition when an object cutting off a field of view of the driver is present on a passenger’s seat of the mobile object or when an external environment is determined to hinder the visibility of the driver.

(8) In the aspect of (7), the object may include an occupant, and the determiner may not loosen the sideways-glance determination condition when the occupant is present on the passenger’s seat of the mobile object and an inclination angle of the passenger’s seat is equal to or greater than a predetermined angle.

(9) In the aspect of (1), the determiner loosens the sideways-glance determination condition when an amount of change in posture of the driver is greater than a predetermined amount.

(10) The driver state detection device according to the aspect of (1)) may further include an alarm controller configured to output an alarm when an amount of change in gaze of the driver recognized by the recognizer is less than a predetermined amount while the mobile object is swinging.

(11) According to another aspect of the present invention, there is provided a driver state detection method that is performed by a computer, the driver state detection method including: recognizing at least one of a gaze and a face direction of a driver of a mobile object; determining whether the driver is performing sideways-glance driving on the basis of a result of recognition and a sideways-glance determination condition; performing the determination of sideways-glance driving using a first sideways-glance determination condition when a swing of the mobile object is not predicted and when the mobile object is not swinging; performing the determination of sideways-glance driving using a second sideways-glance determination condition when a swing of the mobile object is predicted or when the mobile object is swinging; and changing a swing determination condition for determining whether the mobile object is swinging according to whether a swinging direction of the mobile object is right or left when it is determined whether the mobile object is swinging.

(12) According to another aspect of the present invention, there is provided a non-transitory computer-readable storage medium storing a program, which causes a computer to perform: recognizing at least one of a gaze and a face direction of a driver of a mobile object; determining whether the driver is performing sideways-glance driving on the basis of a result of recognition and a sideways-glance determination condition; performing the determination of sideways-glance driving using a first sideways-glance determination condition when a swing of the mobile object is not predicted and when the mobile object is not swinging; performing the determination of sideways-glance driving using a second sideways-glance determination condition when a swing of the mobile object is predicted or when the mobile object is swinging; and changing a swing determination condition for determining whether the mobile object is swinging according to whether a swinging direction of the mobile object is right or left when it is determined whether the mobile object is swinging.

According to the aspects of (1) to (12), it is possible to more appropriately detect a driver state according to a moving situation of a mobile object.

### BRIEF DESCRIPTION OF THE DRAWINGS

FIG. 1 is a diagram illustrating a configuration of a vehicle system including a driver state detection device according to an embodiment.

FIG. 2 is a diagram illustrating a relationship between a driver’s gaze and sideways-glance determination conditions.

FIG. 3 is a diagram illustrating a changed sideways-glance determination area.

FIG. 4 is a diagram illustrating right or left turn and swing determination.

FIG. 5 is a flowchart illustrating an example of a process flow that is performed by a driving support device according to the embodiment.

### DESCRIPTION OF EMBODIMENTS

Hereinafter, a driver state detection device, a driver state detection method, and a storage medium according to an embodiment of the present invention will be described with reference to the accompanying drawings. In the following description, it is assumed that a vehicle is used as an example of a mobile object. Examples of the mobile object may include a ship which can move on the ground (on a road) such as a hovercraft, a flying object which can travel on a road, and a standing riding vehicle including a power unit in addition to a vehicle. In the following description, a case in which left-handed traffic rules are applied will be mainly described, and right and left can be exchanged when right-handed traffic rules are applied.

### Entire configuration

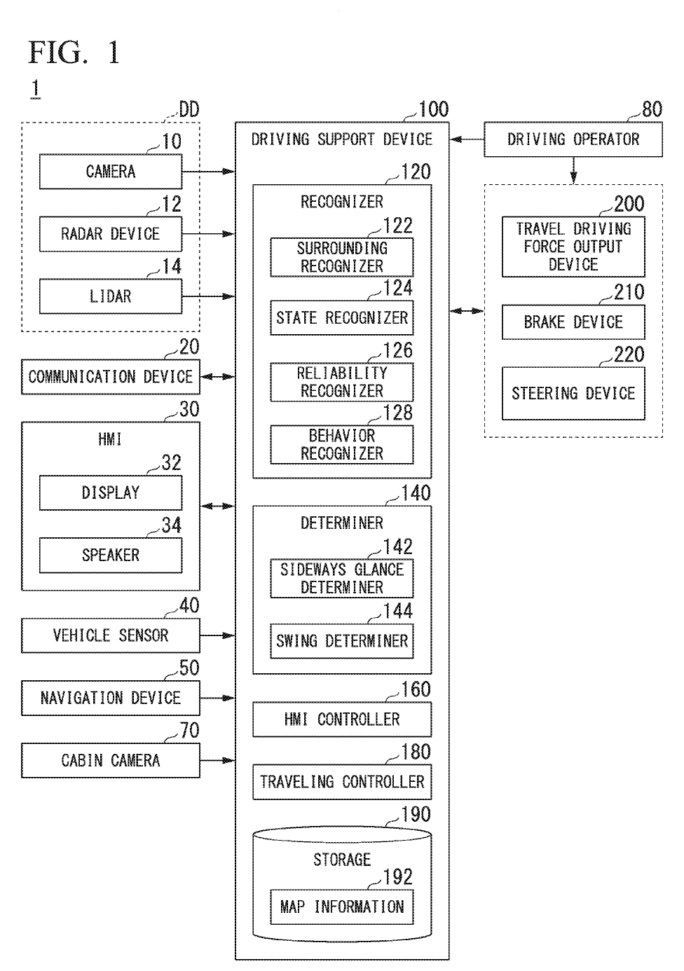

FIG. 1 is a diagram illustrating a configuration of a vehicle system 1 employing a driver state detection device according to an embodiment. A vehicle in which the vehicle system 1 is mounted (hereinafter referred to as a vehicle M) is, for example, a vehicle with two wheels, three wheels, or four wheels or micromobility, and a drive source thereof is an internal combustion engine such as a diesel engine or a gasoline engine, an electric motor, or a combination thereof. The electric motor operates using electric power generated by a power generator connected to the internal combustion engine or using electric power discharged from a battery (storage battery) such as a secondary battery or a fuel cell.

The vehicle system 1 includes, for example, a camera 10, a radar device 12, a Light Detection and Ranging (LIDAR) device 14, a communication device 20, a human-machine interface (HMI) 30, a vehicle sensor 40, a navigation device 50, a cabin camera 70, a driving operator 80, a driving support device 100, a travel driving force output device 200, a brake device 210, and a steering device 220. These devices or instruments are connected to each other via a multiplex communication line such as a controller area network (CAN) communication line, a serial communication line, a radio communication network, or the like. The configuration illustrated in FIG. 1 is only an example, and a part of the configuration may be omitted or another configuration may be added thereto. A combination of the camera 10, the radar device 12, and the LIDAR device 14 is an example of a “detection device DD.” The HMI 30 is an example of an “alarm.”

The camera 10 is, for example, a digital camera using a solid-state imaging device such as a charge coupled device (CCD) or a complementary metal oxide semiconductor (CMOS). The camera 10 is attached to an arbitrary position on the vehicle M in which the vehicle system 1 is mounted. When a forward view is imaged, the camera 10 is attached to an upper part of a front windshield, a rear surface of a rearview mirror, a front head of a vehicle body, or the like. When a rearward view is imaged, the camera 10 is attached to an upper part of a rear windshield, a back door, or the like. When a side view is imaged, the camera 10 is attached to a door mirror or the like. The camera 10 images the surroundings of the vehicle M, for example, periodically and repeatedly. The camera 10 may be a stereo camera.

The radar device 12 radiates radio waves (radiated waves) such as millimeter waves to the surroundings of the vehicle M, detects radio waves (reflected waves) reflected by a nearby object, and detects at least a position (a distance and a direction) of the object. The radar device 12 is attached to an arbitrary position on the vehicle M. The radar device 12 may detect a position and a speed of an object using a frequency modulated continuous wave (FM-CW) method.

The LIDAR device 14 radiates light to the surroundings of the vehicle M and measures scattered light. The LIDAR device 14 detects a distance to an object on the basis of a time from radiation of light to reception of light. The radiated light is, for example, a pulse-like laser beam. The LIDAR device 14 is attached to an arbitrary position on the vehicle M.

The communication device 20 communicates with other vehicles near the vehicle M, a terminal device of a user using the vehicle M, or various server devices, for example, using a network such as a cellular network, a Wi-Fi network, Bluetooth (registered trademark), or dedicated short range communication (DSRC), a local area network (LAN), a wide area network (WAN) or the Internet.

The HMI 30 presents various types of information to an occupant (who includes a driver) of the vehicle M and receives an input operation from the occupant. The HMI 30 includes, for example, a display 32 and a speaker 34. The display 32 is, for example, a liquid crystal display (LCD) device or an organic electroluminescence (EL) display device. The display 32 displays various images (including a video) according to the embodiment. The display 32 may be configured as a touch panel which is a unified body with an input. The speaker 34 outputs predetermined sound (for example, an alarm sound). The HMI 30 may include a microphone, buzzers, a touch panel, switches, and keys in addition to (or instead of) the display 32 and the speaker 34.

The vehicle sensor 40 includes a vehicle speed sensor that detects a speed of the vehicle M, an acceleration sensor that detects acceleration, and a yaw rate sensor that detects a yaw rate (for example, an angular velocity around a vertical axis passing through the center of gravity of the vehicle M). The vehicle sensor 40 may include a lateral acceleration sensor (a lateral G sensor) that detects a lateral acceleration (a lateral G) of the vehicle M, a rudder angle sensor that detects a rudder angle of the vehicle M (which may be an angle of turning wheels or a steering angle of a steering wheel), a rudder angular velocity sensor that detects a rudder angular velocity, or a direction sensor that detects a direction of the vehicle M.

The vehicle sensor 40 may include a position sensor that detects a position of the vehicle M. The position sensor is, for example, a sensor that acquires position information (longitude and latitude information) from a global positioning system (GPS) device. The position sensor may be, for example, a sensor that acquires position information using a global navigation satellite system (GNSS) receiver of the navigation device 50. The vehicle sensor 40 may derive the speed of the vehicle M from a difference in position information in a predetermined time (that is, a distance) in the position sensor.

The vehicle sensor 40 may include an illuminance sensor that detects illuminance (brightness) in the cabin or a weather sensor that detects the weather near the vehicle M. For example, the weather sensor may detect outside humidity or temperature and predict the weather on the basis of the detection result and an operating situation of a wiper of the vehicle M, and the like or may acquire weather information near the vehicle M with respect to the position of the vehicle M acquired by the position sensor or the like from an external device connected thereto via the communication device 20. The vehicle sensor 40 may include a seat sensor that detects a position of a seat in the vehicle M or an inclination angle of a backrest (a seat back) (an angle formed by a seat and a backrest). Results detected by the vehicle sensor 40 are output to the driving support device 100.

The navigation device 50 includes, for example, a GNSS receiver, a navigation HMI, and a route determiner. The navigation device 50 may store map information in a storage device such as a hard disk drive (HDD) or a flash memory or acquire map information 192 stored in a storage 190 which will be described later. The GNSS receiver identifies the position of the vehicle M on the basis of signals received from GNSS satellites. The position of the vehicle M may be identified or corrected by an inertial navigation system (INS) using the output of the vehicle sensor 40. The navigation HMI includes a display device, a speaker, a touch panel, and keys. The GNSS receiver may be provided in the vehicle sensor 40. The navigation HMI may be partially or wholly shared by the HMI 30. For example, the route determiner determines a route (hereinafter referred to as a route on a map) from the position of the vehicle M identified by the GNSS receiver (or an input arbitrary position) to a destination input by an occupant using the navigation HMI, for example, with reference to the map information 192. The navigation device 50 performs route guidance using the navigation HMI on the basis of the determined route on a map. The navigation device 50 may transmit a current position and a destination to a navigation server via the communication device 20 and acquire a route which is equivalent to the route on a map from the navigation server.

Here, the map information 192 is, for example, information in which a road shape is expressed by links indicating a road (an example of a traveling lane) and nodes connected by the links. The map information 192 may include point of interest (POI) information. The map information 192 includes, for example, the number of lanes (the number of traveling lanes), a type or shape of road marking lines, information of a lane center, or information of road boundaries. The map information 192 may include information indicating whether a road boundary is a boundary (a physical boundary) including a structure which a vehicle cannot pass through (which includes crossing or contacting). A physical boundary is, for example, a guardrail, a curbstone, a median strip, or a fence. The map information 192 may include road shape information, traffic regulation information, address information (addresses and postal codes), facility information, parking lot information, and phone number information. The road shape information is, for example, information on a curvature (which may be a radius of curvature; the same is true of the following description), a width, a surface gradient, a branching or merging point, a crossing, or a T-road of a road. The map information 192 may be updated from time to time by causing the communication device 20 to communicate with an external device.

The cabin camera 70 is, for example, a digital camera using a solid-state imaging device such as a CCD or a CMOS device. The cabin camera 70 is attached to an arbitrary position on the vehicle M in a place and a direction in which the head of a driver sitting on a driver’s seat of the vehicle M can be imaged from the front (such that the face of the driver is imaged). For example, the cabin camera 70 is attached to an upper part of a display device which is provided at the center of an instrument panel of the vehicle M. The cabin camera 70 images the cabin in an area including an occupant (passenger) sitting on a passenger’s seat of the vehicle M.

The driving operator 80 includes, for example, a steering wheel, an accelerator pedal, and a brake pedal. The driving operator 80 may include a shift lever, a deformed steering wheel, a joystick, or other operators. For example, an operation detector that detects an amount of operation of a corresponding operator or whether an operation has been performed thereon by the driver is attached to the corresponding operator of the driving operator 80. The operation detector detects, for example, a steering angle or a steering torque (for example, an amount of steering (a steering input torque) based on the driver’s driving operation) of the steering wheel, a rate of change in steering torque, and an amount of depression of the accelerator pedal or the brake pedal. Then, the operation detector outputs the results of detection to the driving support device 100 or some or all of the travel driving force output device 200, the brake device 210, and the steering device 220. The driving operator 80 may include a direction indicator (a turn signal lever or a turn lever). When the direction indicator is operated, a turn signal (the direction indicator) of the vehicle M correlated with details of the operation blinks, and the operation details (for example, which include a result of detection indication that the operator is operated by the driver) are output to the driving support device 100.

The driving support device 100 performs various types of control for supporting driving of the driver of the vehicle M. The driving support device 100 includes, for example, a recognizer 120, a determiner 140, an HMI controller 160, a traveling controller 180, and a storage 190. The recognizer 120, the determiner 140, the HMI controller 160, and the traveling controller 180 are realized, for example, by causing a hardware processor such as a central processing unit (CPU) to execute a program (software). Some or all of these constituents may be realized by hardware (a circuit part including circuitry) such as a large scale integration (LSI) device, an application-specific integrated circuit (ASIC), or a field-programmable gate array (FPGA), a graphics processing unit (GPU), or a system on chip (SOC) or may be cooperatively realized by software and hardware. The program may be stored in a storage device (a storage device including a non-transitory storage medium) such as an HDD or a flash memory of the driving support device 100 in advance, or may be stored in a removable storage medium such as a DVD, a CD-ROM, or a memory card and installed in the storage device of the driving support device 100 by setting the storage medium (a non-transitory storage medium) into a drive device or a card slot. The HMI controller 160 is an example of an “alarm controller.” The recognizer 120, the determiner 140, and the HMI controller 160 are an example of a “driver state detection device.”

The storage 190 may be realized by the aforementioned various storage devices, an electrically erasable programmable read only memory (EEPROM), a read only memory (ROM), a random access memory (RAM), or the like. For example, the map information 192 and various types of information and programs in the embodiment are stored in the storage 190. Various types of setting information used in processes according to the present embodiment may be stored in the storage 190.

The recognizer 120 includes, for example, a surrounding recognizer 122, a state recognizer 124, a reliability recognizer 126, and a behavior recognizer 128.

The surrounding recognizer 122 recognizes a surrounding situation of the vehicle M, for example, on the basis of the results of detection from a detection device DD (information input from the camera 10, the radar device 12, and the LIDAR device 14). For example, the surrounding recognizer 122 recognizes states such as a position (relative position), a size, a speed (relative speed), and an acceleration of an object near the vehicle M (for example, within a predetermined distance from the vehicle M) by performing a sensor fusion process on the results of detection from some or all of the camera 10, the radar device 12, and the LIDAR device 14. Examples of the object recognized by the surrounding recognizer 122 include a traffic participant (an example of an obstacle) such as another vehicle, a pedestrian, or a bicycle in addition to the physical boundaries defining a road (a traveling lane). For example, a position of an object is recognized as a position in an absolute coordinate system with a representative point (such as the center of gravity or the center of a drive shaft) of the vehicle M as an origin and is used for control. A position of an object may be expressed as a representative point such as the center of gravity or a corner of the object or may be expressed as an area. A “state” of an object may include, for example, an acceleration or a jerk of a mobile object or a “moving state” (for example, whether another vehicle is performing lane change or whether another vehicle is going to performing lane change) when the object is a mobile object such as another vehicle.

The surrounding recognizer 122 may recognize, for example, a stop line, a red signal, a toll gate, other road events, a road sign, or a marking drawn on a road (for example, a speed limit).

The surrounding recognizer 122 recognizes, for example, a lane (a traveling lane) in which the vehicle M is traveling or a lane (for example, an opposing lane) near the traveling lane. For example, the surrounding recognizer 122 recognizes road marking lines from an image captured by the camera 10 and recognizes the traveling lane or other lanes on the basis of a positional relationship of the vehicle M with the recognized road marking lines. The surrounding recognizer 122 may recognize the traveling lane of the vehicle M and other lanes with reference to the amp information 192 on the basis of the position information of the vehicle M acquired from the vehicle sensor 40 or the like.

The state recognizer 124 recognizes a state of an occupant of the vehicle M using an image captured by the cabin camera 70. For example, the state recognizer 124 performs a known image analysis process on the image captured by the cabin camera 70 and recognizes a gaze of the driver (a direction in which the driver is gazing) of the vehicle M or a face direction of the driver on the basis of a result of analysis.

For example, the state recognizer 124 detects a combination of a reference point (a part in which the eye does not move) and a moving point (a part in which the eye moves) of eyes of the driver from the image using a technique such as template matching. The combination of the reference point and the moving point is, for example, a combination of an inner canthus and an iris or a combination a corneal reflection area and a pupil. The corneal reflection area is an infrared reflection area in a cornea when the cabin camera 70 or the like irradiates the driver with infrared light. Then, the state recognizer 124 recognizes a gaze of the driver by performing coordinate conversion from an image plane to a real space on the basis of the position of the moving point relative to the reference point. The state recognizer 124 recognizes a face direction of the driver on the basis of position information of eyes, a nose, a mouse or the like (relative position information of the regions) in a face area acquired from the analysis result of the image.

The state recognizer 124 may recognize an eye shape of the driver from the analysis result of an image or recognize sunglasses or eyeglasses worn by the driver through template matching or the like. The state recognizer 124 may determine whether the driver is monitoring the surroundings of the vehicle M on the basis of the gate or the face direction of the driver. The state recognizer 124 may recognize a posture (a motion) or an amount of change (an amount of motion) of the driver in a predetermined time.

When there is an occupant (for example, a passenger sitting on the passenger’s seat) other than the driver, the state recognizer 124 may recognize a position, a gaze, a face direction, or the like of the occupant. In the aforementioned recognition of various types of information using an image, for example, a trained model which has been trained through machine learning or the like in advance may be used.

The reliability recognizer 126 recognizes the reliability of the recognition result from the state recognizer 124. For example, the reliability recognizer 126 sets the reliability of the recognition result to be less when a face direction of the driver has been recognized but a gaze has not been recognized by the state recognizer 124 than when the gaze has also been recognized. When the driver is recognized to wear sunglasses or eyeglasses or when the driver has small eyes, there is a likelihood that the moving points of eyes will not be correctly recognized, and thus the reliability recognizer 126 decreases the reliability of a recognition result when the gaze has also been recognized. The state recognizer 124 may decrease the reliability of recognition as the illuminance decreases (becomes darker) according to the illuminance acquired by the vehicle sensor 40. The reliability recognizer 126 may set the reliability of the recognition result in a preset nighttime to be less than the reliability of the recognition result in the daytime (a time period other than the nighttime). Since a captured image is darker in the certain weather (for example, foggy or rainy) than in the other weather and it is more difficult to recognize the gaze or the face direction, the reliability recognizer 126 may decrease the reliability of the recognition result on the basis of the weather near the vehicle M acquired by the vehicle sensor 40. The reliability recognizer 126 may recognize the reliability by combining two or more of the plurality of techniques described above.

The behavior recognizer 128 recognizes behavior of the vehicle M on the basis of the detection results from the vehicle sensor 40. For example, the behavior recognizer 128 recognizes a lateral position of the vehicle M (a position in a lane width direction) with respect to the traveling lane or a posture (direction) of the vehicle M with respect to an extending direction of the traveling lane on the basis of the positional relationship between the vehicle M and the traveling lane. For example, the behavior recognizer 128 may recognize a degree of separation of a reference point of the vehicle M from the lane center and an angle of the traveling direction of the vehicle M with respect to a line formed by connecting the lane centers as the relative position and the relative posture of the vehicle M with respect to the traveling lane. Instead, the behavior recognizer 128 may recognize a position of the reference point of the vehicle M with respect to one side line of the traveling lane (a road marking line or a road boundary) or the like as the relative position (a lateral position) of the vehicle M with respect to the traveling lane. The behavior recognizer 128 may recognize lateral behavior of the vehicle M (for example, when the vehicle M moves laterally by a predetermined distance or longer) from the lateral position of the vehicle M or an amount of change in direction of the vehicle M. The behavior recognizer 128 may recognize the lateral behavior of the vehicle M on the basis of the values of the rudder angle, the rudder angular velocity, the yaw rate, and the like of the vehicle M acquired from the vehicle sensor 40 or at least one value of a steering torque and a rate of change in steering torque acquired from the driving operator 80.

The determiner 140 includes, for example, a sideways glance determiner 142 and a swing determiner 144. The sideways glance determiner 142 determines whether the driver is performing sideways-glance driving on the basis of at least one of the gaze and the face direction of the driver recognized by the state recognizer 124 and a preset sideways-glance determination condition. When it is determined that the driver is performing sideways-glance driving, the sideways glance determiner 142 notifies an occupant including the driver by causing the HMI controller 160 to output alarm information on the sideways-glance driving. The alarm information is, for example, sideways-glance alarm information such as information for notifying that a sideways glance has been detected or information for attracting attention against a sideways glance and includes at least one of an image and sound (alarm sound). For example, when the swing determiner 144 determines that the vehicle M is swinging, the sideways glance determiner 142 change the sideways-glance determination condition.

The swing determiner 144 determines whether the vehicle M is swinging on the basis of the detection results from the vehicle sensor 40 and a preset swing determination condition. Instead of (or in addition to) the detection results from the vehicle sensor 40, the swing determiner 144 may use information acquired from the driving operator 80 or may use information on the behavior of the vehicle M recognized by the behavior recognizer 128. The swing includes, for example, right or left turn of the vehicle M, traveling on a curved road, and traveling with lateral fluctuations. Process details of the sideways glance determiner 142 and the swing determiner 144 will be described later.

The HMI controller 160 notifies an occupant of predetermined information using the HMI 30 or receives information input by the HMI 30. The predetermined information includes, for example, information associated with traveling of the vehicle M such as information on the state of the vehicle M or information on driving control. The information on the state of the vehicle M includes, for example, a speed, an engine rotation speed, and a shift position of the vehicle M. The information on driving control includes, for example, information indicating whether driving control is to be performed by the traveling controller 180 or information on an execution situation of driving control. The predetermined information may include information on the surrounding situation recognized by the detection device DD. The predetermined information may include information not associated with traveling of the vehicle M such as television programs and content (for example, movies) stored in a storage medium such as a DVD. For example, the predetermined information may include information on a current position or a destination of the vehicle M and a residual amount of fuel of the vehicle M. The HMI controller 160 may output the information received by the HMI 30 to the communication device 20, the recognizer 120, the determiner 140, the navigation device 50, and the like.

The HMI controller 160 may cause the HMI 30 to output inquiry information for an occupant, the recognition results from the recognizer 120, the determination results from the determiner 140, and the like. The HMI controller 160 may transmit various types of information which the HMI 30 is caused to output to a terminal device used by the occupant of the vehicle M via the communication device 20.

The traveling controller 180 performs driving control for controlling at least one of steering and speed of the vehicle M on the basis of the recognition results from the recognizer 120, the determination results from the determiner 140, or the like. For example, when the determiner 140 determines that the driver is performing sideways-glance driving and this state is maintained for a predetermined time or longer, the traveling controller 180 performs control for stopping the vehicle M at a safe position such as a road shoulder. The traveling controller 180 may perform the driving control such that collision of the vehicle M with an obstacle recognized by the surrounding recognizer 122 is avoided. The traveling controller 180 may perform driving control such as an adaptive cruise control system (ACC), a lane keeping assistance system (LKAS), or lane change assist (LCA) by controlling at least one of steering and speed of the vehicle M in accordance with an occupant’s instruction input from the HMI 30.

The travel driving force output device 200 outputs a travel driving force (a torque) for allowing the vehicle to travel to driving wheels. The travel driving force output device 200 includes, for example, a combination of an internal combustion engine, an electric motor, and a transmission and an electronic control unit (ECU) that controls them. The ECU controls the aforementioned constituents on the basis of information input from the traveling controller 180 or information input from the accelerator pedal of the driving operator 80.

The brake device 210 includes, for example, a brake caliper, a cylinder that transmits a hydraulic pressure to the brake caliper, an electric motor that generates a hydraulic pressure in the cylinder, and a brake ECU. The brake ECU controls the electric motor on the basis of the information input from the traveling controller 180 or the information input from the brake pedal of the driving operator 80 such that a brake torque based on a braking operation is output to vehicle wheels. The brake device 210 may include a mechanism for transmitting a hydraulic pressure generated by an operation of the brake pedal to the cylinder via a master cylinder as a backup. The brake device 210 is not limited to the above-mentioned configuration, and may be an electronically controlled hydraulic brake device that controls an actuator on the basis of information input from the traveling controller 180 such that the hydraulic pressure of the master cylinder is transmitted to the cylinder.

The steering device 220 includes, for example, a steering ECU and an electric motor. The electric motor changes a direction of turning wheels, for example, by applying a force to a rack-and-pinion mechanism. The steering ECU drives the electric motor on the basis of the information input from the traveling controller 180 or the information input from the steering wheel of the driving operator 80 and changes the direction of the turning wheels.

### Sideways glance determiner and swing determiner

Details of the functions of the sideways glance determiner 142 and the swing determiner 144 will be specifically described below. The sideways glance determiner 142 compares a gaze or a face direction of a driver with a sideways-glance determination area (an example of a sideways-glance determination condition) and determines whether the driver is performing sideways-glance driving.

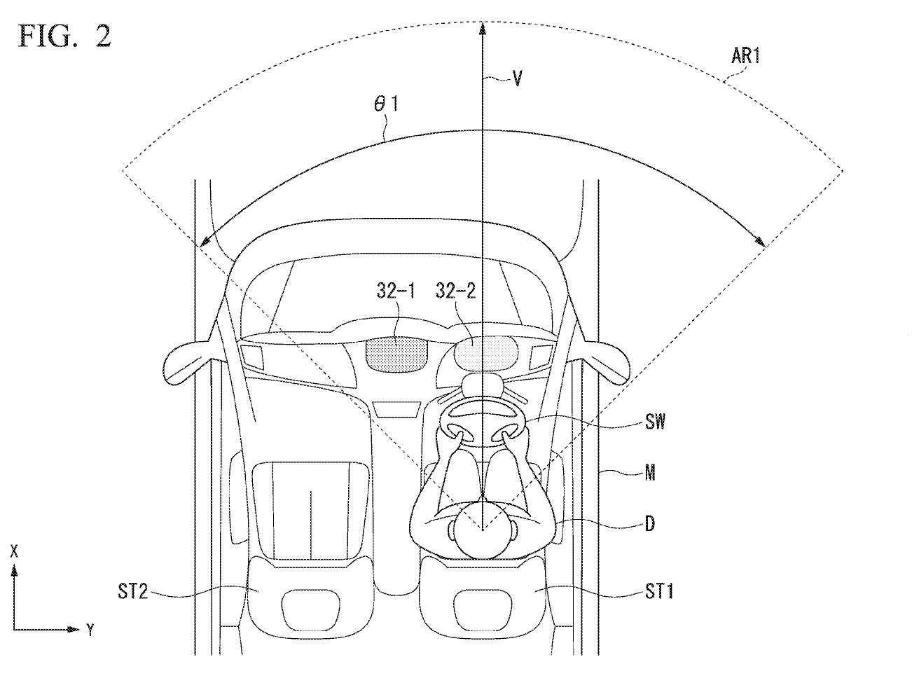

FIG. 2 is a diagram illustrating a relationship between a gaze of a driver and a sideways-glance determination condition. In the example illustrated in FIG. 2, a situation in which a driver D sits on a driver’s seat ST1 of the vehicle M and operates a driving operator such as a steering wheel SW to perform manual driving of the vehicle M is schematically illustrated. In the example illustrated in FIG. 2, displays 32-1 and 32-2 and a passenger’s seat ST2 are illustrated. For example, when the vehicle M is traveling straightly ahead (the X-axis direction in the drawing), the sideways glance determiner 142 sets a sideways-glance determination area AR1 with a predetermined angle to right and left with respect to a traveling direction V of the vehicle M from a position of the head of the driver D as illustrated in FIG. 2. The sideways-glance determination area AR1 is an example of a “first sideways-glance determination condition.” The sideways-glance determination area AR1 may be adjusted according to the speed of the vehicle M, a road shape, or the like. In this case, for example, the sideways-glance determination area AR1 is set such that an angle (an arc angle) θ1 indicating the magnitude of an arc of the sideways-glance determination area AR1 decreases according to the magnitude of the speed or the angle θ1 increases as a width of a road increases.

In this situation, for example, the sideways glance determiner 142 determines that the driver D is not performing sideways-glance driving when the gaze of the driver D recognized by the state recognizer 124 is included in the angle θ1 of the sideways-glance determination area AR1 and determines that the driver D is performing sideways-glance driving when the gaze is not included in the angle θ1 (or when the state in which the gaze is not included in the angle is maintained for a predetermined time or longer). The sideways glance determiner 142 may perform the sideways-glance determination by comparing the direction of the head of the driver D recognized by the state recognizer 124 with the sideways-glance determination area AR1 instead of (or in addition to) the gaze of the driver D. For example, the sideways glance determiner 142 performs the sideways-glance determination using the face direction when the gaze of the driver D has not been recognized by the state recognizer 124 (or the reliability of the gaze is less than a threshold value) and the face direction has been recognized (or the reliability of the face direction is equal to or greater than a threshold value). The case in which at least one of the gaze and the face direction of the driver D is not included in the sideways-glance determination area AR1 is an example of a “case in which a first sideways-glance determination condition is satisfied.”

When the sideways glance determiner 142 determines that the driver is performing sideways-glance driving, the HMI controller 160 generates information indicating that it is determined that the driver is performing sideways-glance driving (sideways-glance alarm information) and causes the HMI 30 to output the generated information. The sideways-glance alarm information may be an alarm image to be displayed on at least one of the displays 32-1 and 32-2 or may be an alarm sound to be output from the speaker 34.

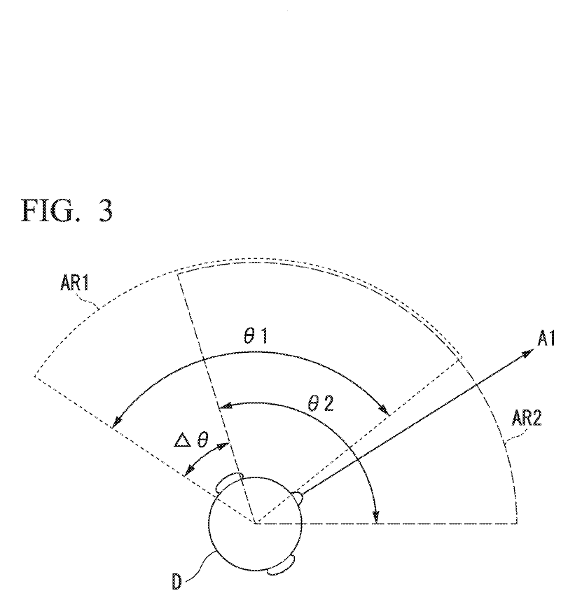

The sideways glance determiner 142 changes the sideways-glance determination area AR1 according to whether the vehicle M is swinging. FIG. 3 is a diagram illustrating a changed sideways-glance determination area. In the example illustrated in FIG. 3, a changing (change) state of the sideways-glance determination area when it is determined that the vehicle M is turning to right is illustrated, and right and left in the following description can be exchanged when the vehicle is turning to left. For example, when it is determined that the vehicle M is swinging (that is, when a swing determination condition which will be described later is satisfied), the sideways glance determiner 142 changes the sideways-glance determination area AR1 to a sideways-glance determination area AR2 corresponding to a swing direction or a swing level (a degree of swing). The sideways-glance determination area AR2 is an example of a “second sideways-glance determination condition.” The sideways-glance determination area AR2 is changed according to the swing direction or the swing level of the vehicle M. For example, the case in which at least one of the gaze and the face direction of the driver D is not included in the sideways-glance determination area AR2 while swinging is an example of a “case in which the second sideways-glance determination condition is satisfied.”

In the example illustrated in FIG. 3, since the vehicle M turns to right, the sideways glance determiner 142 changes the sideways-glance determination area AR1 correlated with straight traveling of the vehicle M to the sideways-glance determination area AR2 at a position obtained by rotationally moving the sideways-glance determination area AR1 by an angle Δθ to right with respect to the head position of the driver D and performs the sideways-glance determination. The angle Δθ may be changed according to the swing level or may be additionally adjusted according to the speed of the vehicle M. In the example illustrated in FIG. 3, the sideways-glance determination area AR1 and the sideways-glance determination area AR2 have the same size (that is, the angle (arc angle) θ1 indicating the size of the sideways-glance determination area AR1 and the angle θ2 indicating the size of the sideways-glance determination area AR2 are the same), but may have different sizes (for example, the angle θ1 and the angle θ2 are different). The angle Δθ, the angle θ1, and the angle θ2 may be adjusted according to a road shape (for example, a width, a curvature, or a connection angle of roads at a crossing) in which the vehicle M is traveling (or which the vehicle M is predicted to travel according to the swing level or a route to a destination) or the like.

For example, it is assumed that a gaze A1 of the driver D is in the situation illustrated in FIG. 3. At this time, when the vehicle M is predicted not to swing or the vehicle M is not swinging, the sideways glance determiner 142 determines that the driver D is not performing sideways-glance driving when the gaze A1 of the driver D is included in the sideways-glance determination area AR1 and determines that the driver D is performing sideways-glance driving when the gaze A1 is not included in the sideways-glance determination area AR1. When the vehicle M is predicted to swing or the vehicle M is swinging, the sideways glance determiner 142 determines that the driver D is not performing sideways-glance driving when the gaze A1 of the driver D is included in the sideways-glance determination area AR2 and determines that the driver D is performing sideways-glance driving when the gaze A1 is not included in the sideways-glance determination area AR2. In the example illustrated in FIG. 3, it is determined that the driver D is performing sideways-glance driving when the vehicle M is predicted not to swing or the vehicle M is not swinging, and it is determined that the driver D is not performing sideways-glance driving when the vehicle M is predicted to swing or the vehicle M is swinging. In this way, by changing the sideways-glance determination condition on the basis of whether the vehicle M is swinging (whether the vehicle M is predicted to swing), it is possible to more appropriately perform sideways-glance determination according to the situation of the vehicle M.

A swing determination condition or the like in the swing determiner 144 will be described below. For example, when it is determined whether the vehicle M is swinging, the swing determiner 144 determines whether the vehicle M is swinging according to whether the swing direction is right or left. For example, when at least one of the rudder angle, the rudder angular velocity, the steering torque, and the yaw rate of the vehicle M or the steering wheel SW detected by the vehicle sensor 40 is equal to or greater than a threshold value set in correlation with corresponding information, the swing determiner 144 determines that the vehicle M is swinging. The swing determiner 144 may determine whether the vehicle M is predicted to swing (whether the vehicle M is to swing in the near future) on the basis of whether a predetermined condition is satisfied. For example, when the direction indicator (the turn signal lever or the turn lever) is operated by the driver D, the swing determiner 144 determines that the vehicle M is predicted to swing. When at least one of the rudder angle, the rudder angular velocity, the steering torque, and the yaw rate is less than the threshold value set in correlation with the corresponding information and an amount of change thereof tends to increase (the amount of change increases for a predetermined time or longer), the swing determiner 144 may determine that the vehicle M is predicted to swing. The swing determiner 144 changes the right or left threshold value according to whether the swing direction (the direction) of the vehicle M is right or left, or the like. Accordingly, since the vehicle M is determined to be swinging at different timings for the right and left sides, the sideways-glance determination condition is changed at different timings for the right and left sides.

When the swing determiner 144 performs the determination using the same threshold value for the right and left sides and performs control such that the sideways-glance determination condition is changed when a predetermined time has elapsed or the vehicle M has traveled a predetermined distance after the vehicle M is predicted to swing or determined to being swinging, the predetermined time or the predetermined distance may be set to different from the right and left sides. This case corresponds to an example of “swing determination condition is changed.”

For example, when the vehicle M turns to right or left without crossing (passing through) an opposing lane opposing the traveling lane of the vehicle M while swinging in the embodiment (a right or left turn of the vehicle M, traveling on a curved road, traveling with right and left fluctuations, or the like), the swing determiner 144 sets the sideways-glance determination condition to be more easily changed than when the vehicle M turns to right or left while crossing (passing through) the opposing lane. Whether the vehicle M crosses the opposing lane is determined, for example, on the basis of the recognition results of the surrounding recognizer 122. Whether the vehicle is turning to right or left may be determined on the basis of the road shape recognized by the surrounding recognizer 122 and the traveling direction (a traveling route to a destination) of the vehicle M or may be determined by additionally determining whether the value of at least one of the rudder angle, the rudder angular velocity, the steering torque, the yaw rate, and the like is included in a preset range for right or left turn. This determination is performed, for example, by the swing determiner 144 or the sideways glance determiner 142. “Set sideways-glance determination condition to be more easily changed” may be replaced with, for example, “change the swing determination condition such that the vehicle is more easily determined to be swinging.”

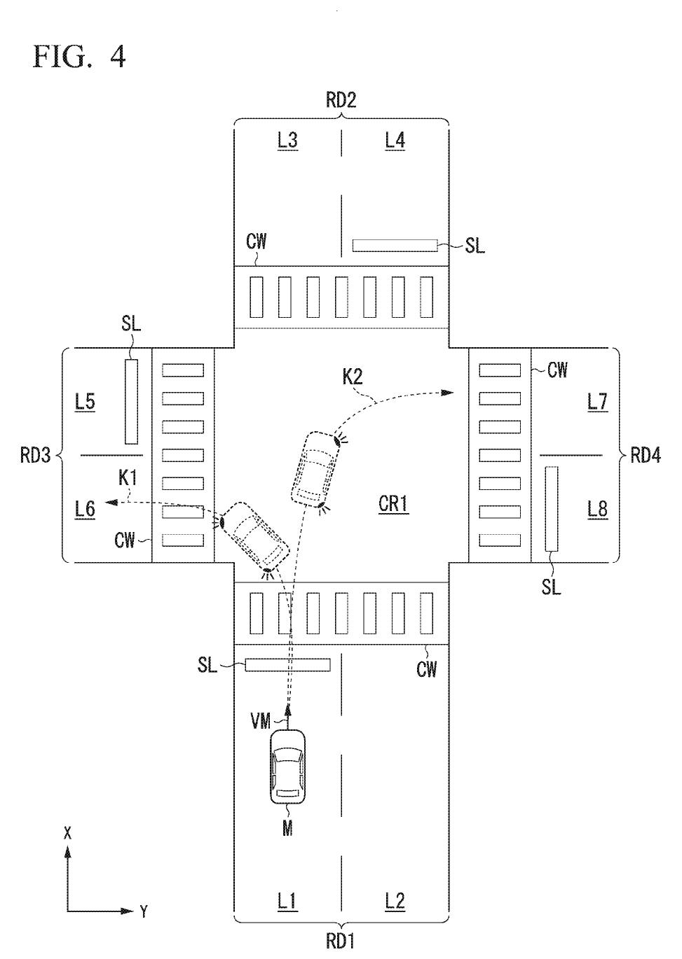

FIG. 4 is a diagram illustrating right or left turn and swing determination. In the example illustrated in FIG. 4, a road R1 including lanes L1 and L2, a road R2 including lanes L3 and L4, a road R3 including lanes L5 and L6, and a road R4 including lanes L7 and L8 are connected at a crossing CR1 to form a cross. In the example illustrated in FIG. 4, the vehicle M is traveling in the lane L1 to the crossing CR1 at a speed VM. The lane L1 is the traveling lane of the vehicle M (a traveling lane in which a mobile object is traveling), and the lane L2 is an opposing lane opposing the lane L1. In the example illustrated in FIG. 4, the lane L3 is present in an extending direction of the lane L1 in the X-axis direction in the drawing, and the lane L4 is present in an extending direction of the lane L2 in the X-axis direction in the drawing. Accordingly, in the crossing CR1, an area extending from the lane L1 to the lane L3 may be referred to as the traveling lane, and an area extending from the lane L4 to the lane L2 may be referred to as the opposing lane. In the example illustrated in FIG. 4, a crosswalk CW and a stop line SL are present in the vicinity of the crossing CR1 in each of the roads R1 to R4.

In the road situation illustrated in FIG. 4, when the vehicle M turns to left in the crossing CR1 and enters the lane L6, this indicates an example in which “the vehicle M turns to left without crossing the opposing lane.” When the vehicle M turns to right in the crossing CR1 and enters the lane L7, it indicates an example in which “the vehicle M turns to right while crossing the opposing lane.” The right or left turn is not limited to the crossing CR1 and includes a case in which the vehicle enters a movable area such as a parking lot or a vacant lot which is present along the road. In FIG. 4, the case in which the vehicle is traveling on a road to which the left-handed traffic rules are applied is illustrated, and the left turn and the right turn can be exchanged when the right-handed traffic rules are applied. When the road is a road having only a one-way lane (a one-way road), the vehicle may be able to turn to right or left without crossing an opposing lane for any of the right turn or the left turn.

For example, when the vehicle M turns to left along a traveling route K1 as illustrated in FIG. 4, the swing determiner 144 changes the swing determination condition such that the sideways-glance determination condition is more easily changed from a first sideways-glance determination condition to a second sideways-glance determination condition even when the vehicle M turns to right along a traveling route K2. Specifically, for example, a threshold value of the rudder angle with which the vehicle M is determined to turn to left may be set to be less than a threshold value of the rudder angle with which the vehicle is determined to turn to right, or the determination conditions for the left turn and the right turn may be set to be different and a condition in which it is more easily determined to be swinging for the left turn may be selected.

For example, when the vehicle M swings without crossing the opposing lane (when the vehicle M turns to left in the crossing CR1 illustrated in FIG. 4), the driver D needs to check the rear side of the vehicle M promptly. On the other hand, when the vehicle M swings while crossing the opposing lane (when the vehicle M turns to right in the crossing CR1 illustrated in FIG. 4), the driver D causes the vehicle M to move to the vicinity of the center of the crossing CR1 and then performs a swing operation of equal to or greater than a threshold value to enter the lane L7. Until moving to the vicinity of the center of the crossing CR1, the driver D gazes at an oncoming vehicle, checks whether an obstacle such as an oncoming vehicle is approaching, and moves the gaze to check the crosswalk CW which is a right turn destination or a preceding vehicle in front when it is determined that the vehicle can advance to the lane L7 side. Accordingly, it is preferable that the sideways-glance determination condition be changed according to this motion. As a result, since a left-turn situation and a right-turn situation of the vehicle M are different in this way, the sideways-glance determination condition can be changed at a more appropriate timing by changing the swing determination condition according to whether the swing direction of the vehicle M is right or left in the embodiment, and thus it is possible to more appropriately detect a driver state (for example, when the driver is glancing sideways). As a result, it is possible to curb occurrence of an uncomfortable alarm.

For example, when the vehicle M turns to right or left without crossing the opposing lane, the swing determiner 144 may set the swing determination condition such that the sideways-glance determination condition is changed when an operation on the direction indicator performed by the driver D has been detected. When the vehicle turns to right or left without crossing the opposing lane, a distance to a road shoulder, a walkway, or the like immediately before the vehicle enters the crossing CR1 is short, and the driver D needs to check the rear side before lateral behavior occurs. Accordingly, by setting the swing determination condition such that the sideways-glance determination condition is changed at the timing at which the operation on the direction indicator has been detected, it is possible to more appropriately perform sideways-glance determination.

When the vehicle M turns to right or left while crossing the opposing lane, the swing determiner 144 may set the swing determination condition such that the sideways-glance determination condition is changed when a driving operation for causing lateral behavior of the vehicle M or lateral behavior of the vehicle M has been detected. The lateral behavior is, for example, movement by a predetermined distance or more in the lane width direction (the Y-axis direction in FIG. 4) (lateral movement) of the vehicle M traveling in the lane L1 and is acquired from the recognition results from the behavior recognizer 128. The driving operation is, for example, a steering operation using the steering wheel SW. Accordingly, for example, when the vehicle moves to the vicinity of the center of the crossing CR1, lateral movement by a predetermined distance or more is not caused, and thus it is possible to perform sideways-glance determination using the determination condition at the time of traveling straightly and to perform sideways-glance determination by providing the determination condition for the right turn at the timing at which the right turn has started actually.

In the embodiment, the sideways-glance determination in the sideways glance determiner 142 may be performed when the vehicle M is traveling (when the speed VM is higher than 0) and may not be performed when the vehicle M stops. In the embodiment, the swing determination in the swing determiner 144 may be performed when the speed VM of the vehicle M while moving is less than a threshold value (a first threshold value) or when an amount of deceleration in a predetermined time is less than a threshold value (a second threshold value). Accordingly, it is possible to change the sideways-glance determination condition in the case of only behavior such as a swing at the decreased speed VM to turn to right or left.

The swing determiner 144 may change the swing determination condition on the basis of the reliability recognized by the reliability recognizer 126. In this case, the swing determiner 144 more easily determines that the vehicle is swinging as the reliability becomes lower. For example, the swing determiner 144 may switch the swing determination condition between when the reliability is lower than a threshold value and when the reliability is equal to or higher than the threshold value or may linearly change the swing determination condition such that the vehicle is more easily determined to be swinging as the reliability becomes lower. When the reliability is low, there is a likelihood that a correct gaze or a correct face direction may not be recognized, and thus there is a high likelihood that the first sideways-glance determination condition will be satisfied and the driver will be erroneously determined to perform sideways-glance driving. Accordingly, in a behavior situation of the vehicle M in which a sideways-glance alarm is troublesome like a swing, it is possible to reduce the trouble by switching the swing determination condition such that the sideways-glance determination condition is switched earlier.

In the embodiment, when an object cutting off a field of view of the driver D is present on the passenger’s seat (for example, the passenger’s seat ST2 in FIG. 2) of the vehicle M or when an external environment hinders the visibility of the driver D, the sideways-glance determination condition may be loosened (relaxed). The object cutting off the field of view of the driver D may include an object actually cutting off at least a part of the field of view and an object not actually cutting off the field of view but estimated to have a likelihood that the object will cut off the field of view. The object includes, for example, an occupant (a passenger), a pet (an animal), and luggage. The luggage is luggage which is larger than a predetermined size. Information indicating whether the object is present on the passenger’s seat of the vehicle M is acquired, for example, from an image captured by the cabin camera 70. The external environment hindering the visibility of the driver D includes, for example, a case in which the vehicle M is in a weather environment such as foggy or rainy and a case in which many traffic participants such as pedestrians or bicycles are present near the vehicle (a case in which the number of traffic participants is equal to or larger than a predetermined number). Whether the external environment hinders the visibility of the driver D may be determined, for example, on the basis of the detection results from the vehicle sensor 40 (for example, the weather sensor) or on the basis of the recognition results from the surrounding recognizer 122.

When the sideways-glance determination condition is loosened (relaxed), it means that it is made to be difficult that the sideways-glance determination condition is determined to be satisfied. In this case, for example, when an occupant sits on the passenger’s seat, the sideways glance determiner 142 sets the angle θ1 indicating the size of the sideways-glance determination area AR1 and the angle θ2 indicating the size of the sideways-glance determination area AR2 to be greater than when no occupant sits on the passenger’s seat. For example, when the external environment hinders the visibility of the driver D, the sideways glance determiner 142 sets the angles θ1 and θ2 to be greater than when the external environment does not hinder the visibility of the driver D. In this way, by loosening the sideways-glance determination condition in an environment in which it is predicted that the field of view is more moved for the purpose of visibility, it is possible to reduce troubles of a sideways-glance alarm.

When an occupant (a passenger) who is an example of an object cutting off the field of view of the driver D is present on the passenger’s seat (for example, the passenger’s seat ST2 in FIG. 2) of the vehicle M and an inclination angle of the backrest (the seat back) acquired from the vehicle sensor 40 (for example, the seat sensor) is equal to or greater than a predetermined angle, the sideways glance determiner 142 may not loosen the sideways-glance determination condition. When the backrest of the passenger’s seat is inclined by a predetermined angle or greater, the field of view from the driver D to the passenger’s seat is not cut off, and thus it is possible to more appropriately perform sideways-glance determination by not changing the sideways-glance determination condition on the basis of another occupant.

In the embodiment, the sideways glance determiner 142 may loosen the sideways-glance determination condition when an amount of change in posture (behavior) of the driver D in a predetermined time acquired from the state recognizer 124 is greater than a predetermined amount. For example, when the driver D adopts a large motion such as movement of a body, there is a likelihood that the gaze direction will be intentionally changed, and thus it is possible to reduce troubles of a sideways-glance alarm by loosening the sideways-glance determination condition (making it difficult to determine that sideways-glance driving is performed) in this case.

In the embodiment, when movement (an amount of change) in gaze in a predetermined time of the driver D recognized by the state recognizer 124 is less than a predetermined amount while the vehicle M is swinging, the HMI controller 160 may cause the HMI 30 to output an alarm. In the aforementioned situation, since it is supposed that the driver D does not monitor the surroundings of the vehicle, it is possible to more appropriately support driving of the driver D by outputting an alarm separately from the sideways-glance determination.

### Process flow

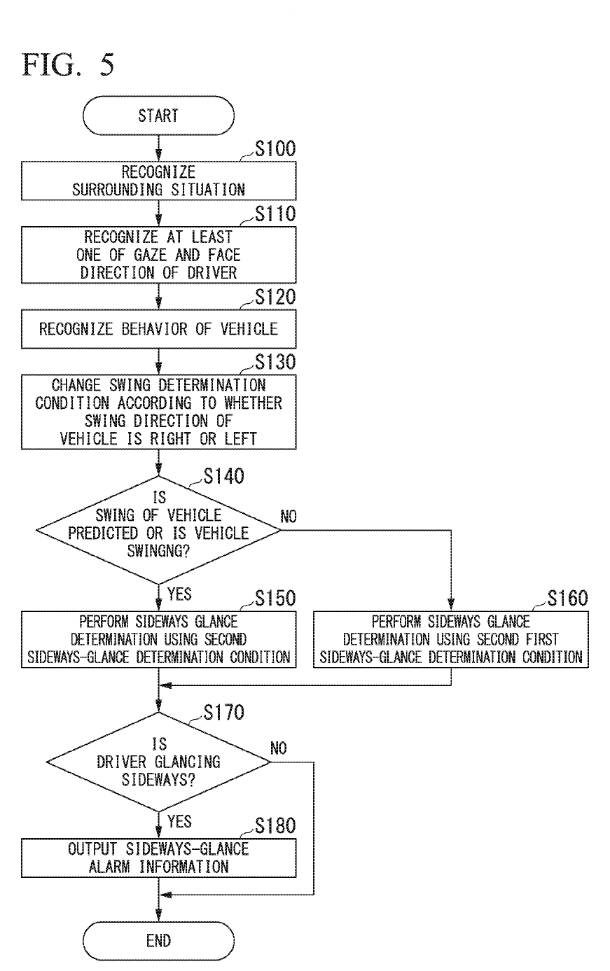

A process flow that is performed by the driving support device 100 according to the embodiment will be described below. In the following description, a process associated with sideways-glance determination of the driver D in the process flow performed by the driving support device 100 will be mainly described. FIG. 5 is a flowchart illustrating an example of the process flow performed by the driving support device 100 according to the embodiment. The process flow illustrated in FIG. 5 may be repeatedly performed at predetermined timings or with a predetermined period.

In the example illustrated in FIG. 5, the surrounding recognizer 122 recognizes the surrounding situation of the vehicle M on the basis of the output from the detection device DD (Step S100). Then, the state recognizer 124 recognizes at least one of a gaze and a face direction of a driver of the vehicle M (Step S110). In the process of Step S110, a degree of the recognized gaze or the recognized face direction of the driver may be recognized. Then, the behavior recognizer 128 recognizes the behavior of the vehicle M (Step S120).

Then, the swing determiner 144 changes the swing determination condition according to whether the swing direction of the vehicle M is right or left (Step S130). Then, the sideways glance determiner 142 determines whether the vehicle M is predicted to swing or the vehicle M is swinging on the basis of the swing determination condition (Step S140). When it is determined that the vehicle M is predicted to swing or the vehicle M is swinging, the sideways glance determiner 142 performs the sideways-glance determination using the second sideways-glance determination condition (Step S150). When it is determined in the process of Step S140 that the vehicle M is predicted not to swing or the vehicle M is not swinging, the sideways glance determiner 142 performs the sideways-glance determination using the first sideways-glance determination condition (Step S160).

Subsequently to Step S150 or S160, the sideways glance determiner 142 determines whether the driver is performing sideways-glance driving (Step S170). When it is determined that the driver is performing sideways-glance driving, the HMI controller 160 causes the HMI 30 to output alarm information on sideways-glance driving (sideways-glance alarm information) (Step S180). Accordingly, the process flow of the flowchart ends. When it is determined in the process of Step S170 that the driver is not performing sideways-glance driving, the process flow of the flowchart ends.

### Modified example

In the embodiment, when the sideways glance determiner 142 determines that the driver is performing sideways-glance driving, the traveling controller 180 may perform driving control for moving the vehicle M to a safe position and stopping the vehicle at the safe position instead of (or in addition to) the control for outputting a sideways-glance alarm. Accordingly, for example, when the driver is performing sideways-glance driving due to bad conditions, it is possible to stop the vehicle M at a safe position and to more appropriately secure safety of the driver.

In the embodiment, the HMI controller 160 may cause the HMI 30 to output information indicating the sideways-glance determination condition (for example, the sideways-glance determination area) or information indicating that the sideways-glance determination condition has been changed. Accordingly, since the driver can be notified of the sideways-glance determination condition based on the situation of the vehicle M, it is possible to curb a sideways glance of the driver and thus to curb an alarm associated with a sideways glance.

According to the aforementioned embodiment, the driver state detection device includes the recognizer 120 configured to recognize at least one of a gaze and a face direction of a driver of a mobile object and the determiner 140 configured to determine whether the driver is performing sideways-glance driving on the basis of a result of recognition from the recognizer 120 and a sideways-glance determination condition. The determiner 140 performs the determination of sideways-glance driving using a first sideways-glance determination condition when a swing of the mobile object is not predicted and when the mobile object is not swinging and performs the determination of sideways-glance driving using a second sideways-glance determination condition when a swing of the mobile object is predicted or when the mobile object is swinging. The determiner 140 changes a swing determination condition for determining whether the mobile object is swinging according to whether a swinging direction of the mobile object is right or left when it is determined whether the mobile object is swinging. Accordingly, it is possible to more appropriately detect the driver state according to a moving situation of the mobile object.

For example, according to the embodiment, since the sideways-glance determination condition can be appropriately changed according to the swing direction of the vehicle M, it is possible to curb occurrence of an uncomfortable alarm. According to the embodiment, for example, since it is necessary to early check the rear side in the case of a right or left turn without crossing the opposing lane, but a viewpoint moves in the case of a right or left turn with crossing the opposing lane such that an oncoming vehicle is checked when the vehicle moves the center of a crossing and a crosswalk at a right or left turn destination is checked when it is determined that the vehicle can travel as it were, it is possible to appropriately control a changing timing of the sideways-glance determination condition according to a left turn or a right turn.

According to the embodiment, since a distance to a road shoulder or a crosswalk in entering a crossing road is short in the case of a right or left turn without crossing an opposing lane and the rear side may be checked before lateral behavior occurs, it is possible to early change the sideways-glance determination condition by changing the sideways-glance determination condition on the basis of an operation of a direction indicator. According to the embodiment, the sideways-glance determination condition can be changed to swinging behavior with decreasing a speed of the right or left turn or the like. According to the embodiment, since the changing timing of the sideways-glance determination condition is changed according to a reliability, it is possible to more appropriately perform sideways-glance determination. According to the embodiment, since there is a likelihood of erroneous determination when the reliability of the recognition result is low, it is possible to reduce troubles by early switching the sideways-glance determination condition in a behavior situation in which the sideways-glance determination condition is troublesome at the time of a swing. According to the embodiment, by loosening (relaxing) the sideways-glance determination condition in a situation in which the driver more moves the field of view to see the surroundings, it is possible to reduce troubles due to an alarm.

The above-mentioned embodiment can be expressed as follows:

A driver state detection device including:

a storage medium storing computer-readable instructions; and

a processor connected to the storage medium,

wherein the processor executes the computer-readable instructions to perform:

recognizing at least one of a gaze and a face direction of a driver of a mobile object;

determining whether the driver is performing sideways-glance driving on the basis of a result of recognition and a sideways-glance determination condition;

performing the determination of sideways-glance driving using a first sideways-glance determination condition when a swing of the mobile object is not predicted and when the mobile object is not swinging;

performing the determination of sideways-glance driving using a second sideways-glance determination condition when a swing of the mobile object is predicted or when the mobile object is swinging; and

changing a swing determination condition for determining whether the mobile object is swinging according to whether a swinging direction of the mobile object is right or left when it is determined whether the mobile object is swinging.

While exemplary embodiments of the present invention have been described above, the present invention is not limited to the embodiments and can have various modifications and substitutions applied thereto without departing from the gist of the present invention.

What is claimed is:

1. A driver state detection device comprising:
a recognizer configured to recognize at least one of a gaze and a face direction of a driver of a mobile object; and
a determiner configured to determine whether the driver is performing sideways-glance driving on the basis of a result of recognition from the recognizer and a sideways-glance determination condition,
wherein the determiner performs the determination of sideways-glance driving using a first sideways-glance determination condition when a swing of the mobile object is not predicted and when the mobile object is not swinging,
wherein the determiner performs the determination of sideways-glance driving using a second sideways-glance determination condition when a swing of the mobile object is predicted or when the mobile object is swinging, and
wherein the determiner changes a swing determination condition for determining whether the mobile object is swinging according to whether a swinging direction of the mobile object is right or left when it is determined whether the mobile object is swinging.

2. The driver state detection device according to claim 1, wherein the swing includes right and left turns of the mobile object, and
wherein the determiner sets the swing determination condition such that the sideways-glance determination condition changes more easily when the mobile object performs a right turn or a left turn without crossing an opposing lane opposing a lane in which the mobile object is moving than when the mobile object performs a right turn or a left turn while crossing the opposing lane.

3. The driver state detection device according to claim 2, wherein the determiner sets the swing determination condition such that the sideways-glance determination condition changes when the mobile object performs a right turn or a left turn without crossing the opposing lane and the driver’s operation of a direction indicator of the mobile object is detected and the sideways-glance determination condition changes when the mobile object performs a right turn or a left turn while crossing the opposing lane and a driving operation of causing lateral behavior of the mobile object or lateral behavior of the mobile object is detected.

4. The driver state detection device according to claim 1, wherein whether the mobile object is swinging is determined when a speed or an amount of deceleration of the mobile object is less than a threshold value.

5. The driver state detection device according to claim 1, wherein the determiner changes the swing determination condition on the basis of a reliability of the result of recognition from the recognizer.

6. The driver state detection device according to claim 5, wherein the determiner loosens the sideways-glance determination condition earlier when the reliability is less than a threshold value than when the reliability is equal to or greater than the threshold value.

7. The driver state detection device according to claim 1, wherein the determiner loosens the sideways-glance determination condition when an object cutting off a field of view of the driver is present on a passenger’s seat of the mobile object or when an external environment is determined to hinder the visibility of the driver.

8. The driver state detection device according to claim 7, wherein the object includes an occupant, and
wherein the determiner does not loosen the sideways-glance determination condition when the occupant is present on the passenger’s seat of the mobile object and an inclination angle of the passenger’s seat is equal to or greater than a predetermined angle.

9. The driver state detection device according to claim 1, wherein the determiner loosens the sideways-glance determination condition when an amount of change in posture of the driver is greater than a predetermined amount.

10. The driver state detection device according to claim 1, further comprising an alarm controller configured to output an alarm when an amount of change in gaze of the driver recognized by the recognizer is less than a predetermined amount while the mobile object is swinging.

11. A driver state detection method that is performed by a computer, the driver state detection method comprising:
recognizing at least one of a gaze and a face direction of a driver of a mobile object;
determining whether the driver is performing sideways-glance driving on the basis of a result of recognition and a sideways-glance determination condition;
performing the determination of sideways-glance driving using a first sideways-glance determination condition when a swing of the mobile object is not predicted and when the mobile object is not swinging;
performing the determination of sideways-glance driving using a second sideways-glance determination condition when a swing of the mobile object is predicted or when the mobile object is swinging; and
changing a swing determination condition for determining whether the mobile object is swinging according to whether a swinging direction of the mobile object is right or left when it is determined whether the mobile object is swinging.

12. A non-transitory computer-readable storage medium storing a program, which causes a computer to perform:
recognizing at least one of a gaze and a face direction of a driver of a mobile object;
determining whether the driver is performing sideways-glance driving on the basis of a result of recognition and a sideways-glance determination condition;
performing the determination of sideways-glance driving using a first sideways-glance determination condition when a swing of the mobile object is not predicted and when the mobile object is not swinging;
performing the determination of sideways-glance driving using a second sideways-glance determination condition when a swing of the mobile object is predicted or when the mobile object is swinging; and
changing a swing determination condition for determining whether the mobile object is swinging according to whether a swinging direction of the mobile object is right or left when it is determined whether the mobile object is swinging.
